(19) United States
(12) Patent Application Publication
(10) Pub. No.: US 2020/0356612 A1
(43) Pub. Date: Nov. 12, 2020

(54) ELECTRONIC CIGARETTE DEVICE, METHOD, AND DEVICE FOR SOCIAL INTERACTION BASED ON ELECTRONIC CIGARETTE DEVICE

(71) Applicant: Goldtek Technology Co., Ltd., New Taipei City (TW)

(72) Inventors: YEN-CHING LEE, New Taipei (TW); PO-SHENG WANG, New Taipei (TW)

(21) Appl. No.: 16/504,551

(22) Filed: Jul. 8, 2019

(30) Foreign Application Priority Data
May 6, 2019 (TW) 108115539

(51) Int. Cl. G06F 16/958; A24F 47/00; G06F 16/29; G01S 19/13; H04W 4/38; H04L 12/58

(52) U.S. Cl. CPC G06F 16/958; A24F 47/008; H04L 51/32; G01S 19/13; H04W 4/38; G06F 16/29

(57) ABSTRACT

A method for broadcasting and sharing user experience of an electronic cigarette includes a computing device receiving data transmitted by the electronic cigarette device, the data comprising user experience of his e-cigarette, location of use, and a time of usage. A first sharing information is generated by the computing device according to the usage information, and the first sharing information can be shared to a social platform. The computing device can analyze the usage information, and generate an analysis report, information for sharing can be generated periodically to the social platform. An e-cigarette device and a computing device which can connect to a social platform are also disclosed.

### FIELD

The disclosure generally relates to electronic cigarettes.

### BACKGROUND

Electronic cigarettes are popular. However, an electronic cigarette presently has no data-sharing function or ability.

Surveys indicate that the purpose of smoking is not only to relax, but also to create and enhance friendships.

### BRIEF DESCRIPTION OF THE DRAWINGS

Implementations of the present technology will now be described, by way of embodiments, with reference to the attached figures.

FIG. 1 is a block diagram illustrating an embodiment of an electronic cigarette device and an electronic cigarette social device.

FIG. 2 is a block diagram illustrating another embodiment of an electronic cigarette device and an electronic cigarette social device.

FIG. 3 is a block diagram illustrating an embodiment of an electronic cigarette system.

FIG. 4 is a block diagram illustrating an embodiment of an electronic cigarette system for social interaction.

FIG. 5 is a flowchart illustrating an embodiment of a method for social interaction based on electronic cigarette.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

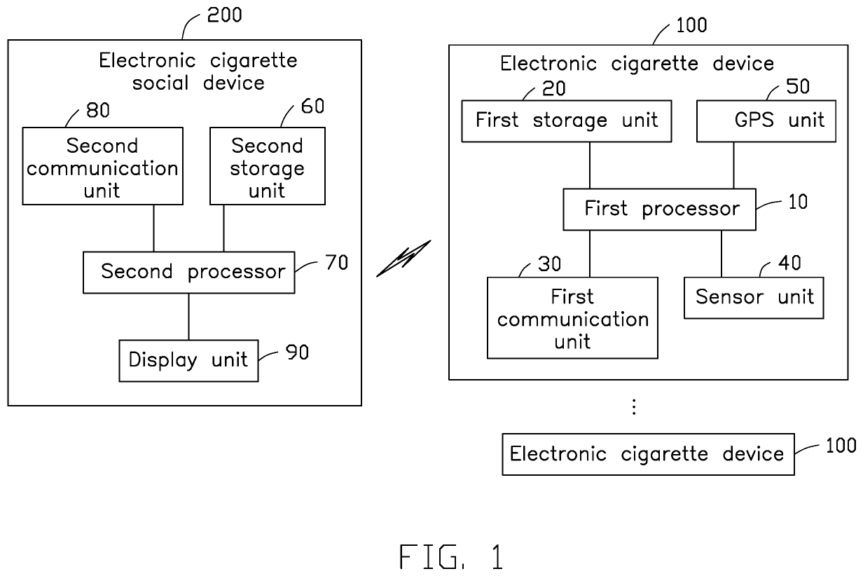

FIG. 1 illustrates an embodiment of an electronic cigarette device (electronic cigarette device 100) and an electronic cigarette social device (ECSD 200). The ECSD 200 can communicate with at least one electronic cigarette device 100.

The electronic cigarette device 100 includes a first processor 10, a first storage unit 20, a first communication unit 30, a sensor unit 40, and a GPS unit 50. The first storage unit 20, the first communication unit 30, the sensor unit 40, and the GPS unit 50 are electrically connected to the first processor 10. The first processor 10, the first storage unit 20, the first communication unit 30 can be integrated.

The first processor 10 may include one or more central processors (CPU), a microprocessor, a digital processing chip, a graphics processor, or a combination of various control chips.

The first storage unit 20 stores various types of data in the electronic device 10, such as program codes and the like. The first storage unit 20 also stores usage information of the electronic cigarette device 100.

The first storage unit 20 can be a hard disk, a floppy disk, a random access storage device, or the like.

In at least one embodiment, the first storage unit 20 can be an internal storage system, such as a flash memory, a random read storage device (RAM), a readable storage device (ROM).

In at least one embodiment, the first storage unit 20 can also be a storage system, such as a memory card or a data storage medium. The first storage unit 20 also includes a volatile and/or a non-volatile storage device.

The first communication unit 30 can wirelessly communicate with the electronic cigarette social device 200. The wireless communication method includes a 5G communication method, a 4G communication method, a 3G communication method, a 2G communication method, or a WI-FI, BLUETOOTH, or the like device based on the TCP/IP protocol.

The sensor unit 40 is configured to collect data as to operations (operation data) of the electronic cigarette device 100. The sensor unit 40 includes at least one of an acceleration sensor, a gyro sensor, a magnetic sensor, a pressure sensor, a temperature sensor, a displacement sensor, a current sensor, and a proximity sensor. The operation data includes times of usage. Optionally, the operation data may further include usage locations.

The GPS unit 50 is configured to acquire position information of the electronic cigarette device 100, the position information is a usage location in the operation data.

The electronic cigarette social device 200 includes a second processor 70, a second storage unit 60, a second communication unit 80, and a display unit 90. The second storage unit 60, the second communication unit 80, and the display unit 90 are electrically connected to the second processor 70. In at least one embodiment, the electronic cigarette social device 200 can include one or more personal computers, or one or more servers.

The second processor 70 may include one or more central processors (CPU), a microprocessor, a digital processing chip, a graphics processor, or a combination of various control chips.

The second storage unit 60 stores various types of data in the electronic cigarette social device 200, such as program codes and the like.

The second storage unit 60 can be a hard disk, a floppy disk, a random access storage device, or the like.

In at least one embodiment, the second storage unit 60 can be an internal storage system, such as a flash memory, a random read storage device (RAM), a readable storage device (ROM).

In at least one embodiment, the second storage unit 60 can also be a storage system, such as a memory card or a data storage medium. The second storage unit 60 also includes a volatile and/or a non-volatile storage device.

The second communicating unit 80 can wirelessly communicate with the first communication unit 30 of at least one electronic cigarette device 100.

The display unit 90 is configured to display various information processed by the second processor 70. The display unit 90 can be a display device, a touch panel, or the like.

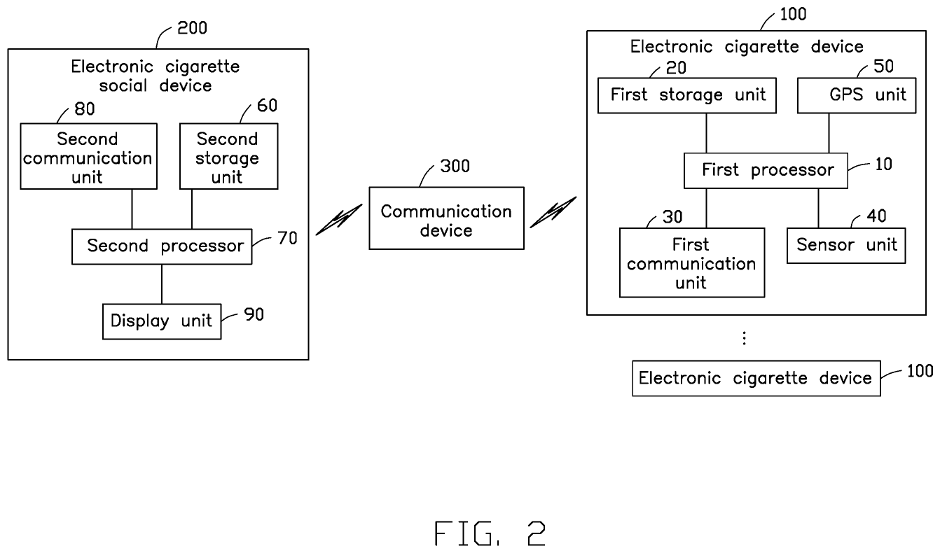

FIG. 2 illustrates another embodiment of the electronic cigarette device 100 and the electronic cigarette social device 200. The electronic cigarette social device 200 communicates with at least one electronic cigarette device 100 through a communication device 300. The communication device 300 can be an intelligent terminal or a TCP/IP protocol-based communication device 300 having a mobile communication function.

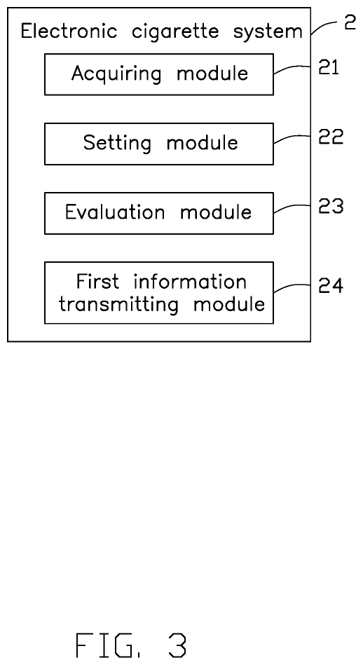

FIG. 3 shows an electronic cigarette system 2 running in the electronic cigarette device 100. The electronic cigarette system 2 may include a plurality of modules, which are a collection of software instructions stored in the first storage unit 20 and executable by the first processor 10. In the embodiment as disclosed, the electronic cigarette system 2 can include an acquiring module 21, a setting module 22, an evaluation module 23, and a first information transmitting module 24.

The acquiring module 21 acquires operation data of the electronic cigarette user. The operational data is collected by the sensor unit 40. The operation data includes a usage time and a user location.

The setting module 22 can set whether the operation data of the user needs to be shared, and can also set data as shareable or as non-shareable.

The evaluation module 23 can evaluate a degree of satisfaction of the current electronic cigarette user, and generates evaluation data. Specifically, the sensor unit 40 senses a pressing of the button, a shaking of the electronic cigarette device 100, or a specific gesture of the user and can send a sensing signal. The evaluation module 23 evaluates the satisfaction according to the sensing signal. For example, continuously pressing the button three times to express satisfaction, and continuously pressing the button four times to indicate dissatisfaction. In one embodiment, the degree of satisfaction can be on a five-point scale, and continuous shaking of the electronic cigarette device 100 five times means five points. The evaluation data includes a type of liquid tobacco, a taste sensation thereof, a record of heat applied, and the degree of satisfaction. Thus very unsatisfactory, unsatisfactory, satisfaction, and great satisfaction can be expressed.

The first information transmitting module 24 transmits usage information including the operational data to the electronic cigarette social device 200 through the first communication unit 30. When the user starts using the electronic cigarette device 100, while the user is using the electronic cigarette device 100, or the user finishes using the electronic cigarette device 100, the electronic cigarette device 100 transmits the usage information to the electronic cigarette social device 200 through the first communication unit 30. The usage information may further include the setting data and the evaluation data.

The electronic cigarette device 100 sends the usage information to the electronic cigarette social device 200, thereby the electronic cigarette social device 200 can judge and analyze the usage information. The electronic cigarette social device 200 can determine whether the electronic cigarette device 100 is being used, and determine whether the usage information includes the evaluation data. Furthermore, the electronic cigarette social device 200 can analyze the usage information, generate the sharing information, and share the sharing information to the social platform. Therefore, users on the social platform can view the sharing information, and users can exchange the e-cigarette user experience and usage habits, to enhance the friendship between friends and make new friends with same e-cigarette habits.

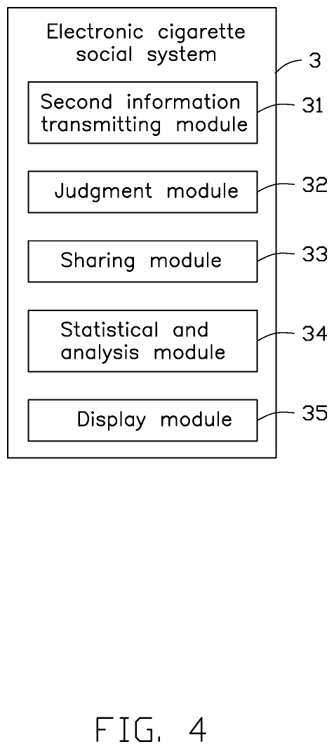

FIG. 4 shows an electronic cigarette social system 3 running in the electronic cigarette social device 100. The electronic cigarette social system 3 may include a plurality of modules, which is a collection of software instructions stored in the second storage unit 60 and executable by the second processor 70. In the embodiment as disclosed, the electronic cigarette social system 3 can include a second information transmitting module 31, a judgment module 32, a sharing module 33, a statistical and analysis module 34, and a display module 35.

The second information transmitting module 31 transmits and receives information. The second information transmitting module 31 can receive the usage information transmitted from the electronic cigarette device 100.

The judgment module 32 determines, according to the usage information, whether the usage information needs to be shared according to the setting of the data. If the usage information needs to be shared, the judgment module 32 further determines whether the electronic cigarette device 100 is in use. If the electronic cigarette device 100 is not being used, the judgment module 32 further determines whether the usage information includes the evaluation data.

The sharing module 33 generates a sharing information and shares the sharing information to a social platform. The sharing information includes a first sharing information, a second sharing information, and a periodic sharing information. The first sharing information includes the user and the information that the user is using the electronic cigarette. For example, the first sharing information may be: Li is using the electronic cigarette, come and join in. The second sharing information includes the evaluation data. The periodic sharing information includes an analysis report. The social platform can be, but is not limited to, QQ, WEIBO, WECHAT, FACEBOOK, TWITTER, and the like.

The statistical and analysis module 34 statistically analyzes the user's electronic cigarette usage habit according to the usage information, and generates an analysis report.

The display module 35 controls the display unit 90 to display the sharing information and the analysis report.

The electronic cigarette device 100 sends the usage information to the electronic cigarette social device 200, thereby the electronic cigarette social device 200 can judge and analyze the usage information. The electronic cigarette social device 200 can determine whether the electronic cigarette device 100 is in use, and determine whether the usage information includes the evaluation data. Furthermore, the electronic cigarette social device 200 can analyze the usage information, generate the sharing information, and share the sharing information to the social platform. Therefore, users on the social platform can view the sharing information, and users can exchange the e-cigarette use experience and usage habits, to enhance the friendship between friends and make new friends with same e-cigarette habits.

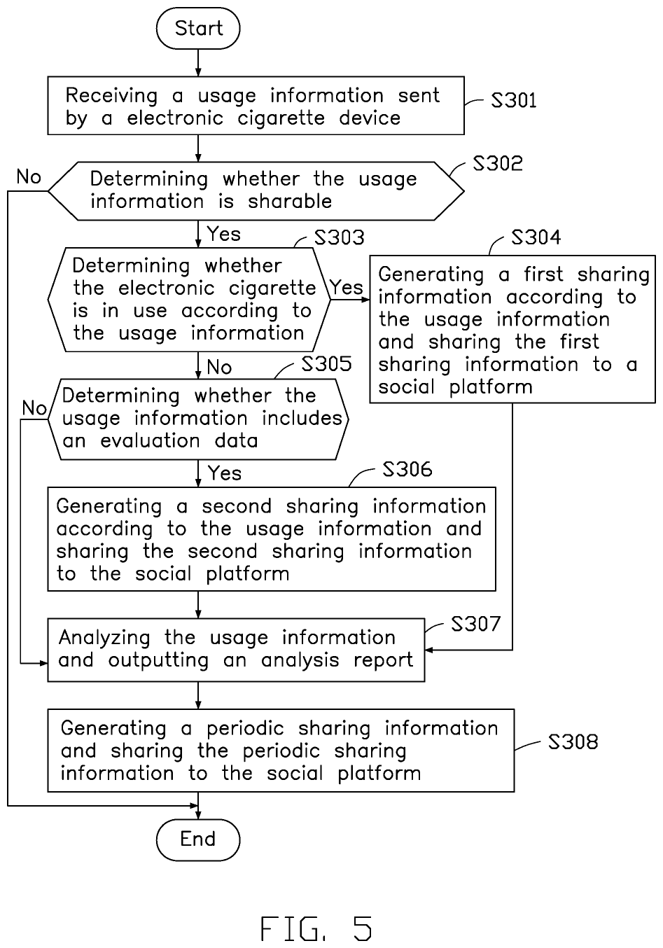

An electronic cigarette social method is illustrated in FIG. 5. The method is provided by way of embodiments, as there are a variety of ways to carry out the method. Each block shown in FIG. 5 represents one or more processes, methods, or subroutines carried out in the example method. Additionally, the illustrated order of blocks is by example only and the order of the blocks can be changed. The method can begin at block S301.

At block S301, the electronic cigarette social device 200 receives the usage information sent by the electronic cigarette device 100.

The second information transmitting module 31 of the electronic cigarette social device 200 receives the usage information sent by the first information transmitting module 24 of the electronic cigarette device 100. The usage information includes the operational data collected by the sensor unit 40 of the electronic cigarette device 100. The operational data includes the usage time and the usage location. The usage information may further include the setting data and the evaluation data. The setting data is set by the setting module 22 and determines whether the usage information needs to be shared. The evaluation data is set by the evaluation data 23 and includes a type of liquid tobacco, a taste sensation thereof, a record of heat applied, and the degree of satisfaction.

At block S302, it is determined that whether the usage information is shareable.

The judgment module 23 of the electronic cigarette social device 200 determines whether the usage information needs to be shared according to the setting data. If not, the process ends. If yes, the process proceeds to block S303.

At block S303, it is determined that whether the electronic cigarette device 100 is i use according to the usage information.

The judgment module 23 of the electronic cigarette social device 200 compare the usage time in the operation data with a system time, and determines whether electronic cigarette device 100 is in use.

If yes, the process proceeds to block S304. If not, the process proceeds to block S305.

At block S304, a first sharing information is generated and shared in a social platform, and then proceeds to block S307.

The sharing module 33 generates the first sharing information according to the usage information, and shares the first sharing information in the social platform, thereby users of the social platform views whether other users are using the electronic cigarette. It is convenient to select the usage time for the user, thereby users can use the electronic cigarette together to promote the friendship between friends. Furthermore, users can make friends with people who share same habits.

At block S305, it is determined that whether the usage information includes an evaluation data.

The judgment module 32 of the electronic cigarette social device 200 determines whether the usage information includes the evaluation data. If yes, proceeds to block S306. If not, proceeds to block S307.

At block S306, a second sharing information is generated and shared to the social platform, and then proceeds to block S307.

The sharing module 33 generates the second sharing information according to the evaluation data, and shares the second sharing information to the social platform. The users on the social platform can make friends with people who have the same or similar habit.

At block S307, the usage information is periodically analyzed and an analysis report is output.

The usage information is stored in the second storage unit 60 as historical data. The statistical and analysis module 34 periodically analyzes the usage information and output the analysis report, which is a statistical table or an analysis chart.

At block S308, an periodic sharing information is generated and shared to the social platform.

The sharing module 33 generates the periodic sharing information according to the analysis report, and shares the periodic sharing information to the social platform, so that other users of the social platform view the usage habit of the electronic cigarette, and then choose to make a relationship according to the usage habit of using the electronic cigarette. The user habit of using the electronic cigarette may include the usage time, the usage location, and the usage setting including the type of tobacco, the taste of use, and the heating record.

In at least one embodiment, after the process of block S308, the electronic cigarette social device 200 may displays the sharing information.

The display module 35 controls the display unit 90 to display the sharing information, thereby users can view the sharing information and users can exchange information and achieve social purpose. The sharing information may include the first sharing information, the second sharing information, and the periodic sharing information.

The above electronic cigarette social method can transmit the usage information of the electronic cigarette device 100 to the electronic cigarette social device 200. The electronic cigarette social device 200 can judge and analyze the usage information, generate the sharing information, and share the sharing information to the social platform. The above electronic cigarette social method can realize exchange of the electronic cigarette use experience between the electronic cigarette users, and then the users can find the electronic cigarette friends with the same hobbies.

A person skilled in the art can understand that all or part of the processes in the above embodiments can be implemented by a computer program to instruct related hardware, and that the program can be stored in a computer readable storage medium. When the program is executed, a flow of steps of the methods as described above may be included.

In addition, each functional device in each embodiment may be integrated in one processor, or each device may exist physically separately, or two or more devices may be integrated in one device. The above integrated device can be implemented in the form of hardware or in the form of hardware plus software function modules.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. An electronic cigarette device, comprising:
a communication unit configured to communicate with an electronic cigarette social device directly or through a communication device;
a sensor unit configured to collect an operation data of the electronic cigarette device, the operation data comprising time of usage;
at least one processor; and
at least one storage device storing one or more programs, when executed by the processor, the one or more programs cause the processor to:
acquire the operation data of the electronic cigarette device;
generate a setting data for setting whether the operation data is sharable according to the operation data; and
send a usage information comprising the operation data and the setting data to the electronic cigarette social device.

2. The electronic cigarette device of claim 1, wherein the electronic cigarette device further comprises a GPS unit for acquiring a location of use of the electronic cigarette device, and the operation data further comprises the location of use.

3. The electronic cigarette device of claim 1, wherein the usage information further comprises an evaluate data, and the evaluate data comprises a type of liquid tobacco, a taste sensation thereof, a record of heating applied, and a degree of satisfaction.

4. The electronic cigarette device of claim 3,
wherein the sensor unit is further configured to sense a pressing of a button on the electronic cigarette device, a shaking of the electronic cigarette device, or a gesture of the user, and send a sensing signal; and
wherein the one or more programs further cause the processor to:
evaluate the degree of satisfaction of the electronic cigarette device according to the sensing signals sent by the sensor unit.

5. The electronic cigarette device of claim 1, wherein the sensor unit comprises at least one of an acceleration sensor, a gyro sensor, a magnetic sensor, a pressure sensor, a temperature sensor, a displacement sensor, a current sensor, and a proximity sensor.

6. An electronic cigarette social device, comprising:
a communication unit configured to communicate with an electronic cigarette device directly or through a communication device;
at least one processor; and
at least one storage device storing one or more programs, when executed by the processor, the one or more programs cause the processor to:
receive, from the electronic cigarette device, a usage information comprising an operation data, the operation data comprising a time of usage;
generate a first sharing information according to the usage information, and share the first sharing information to a social platform;
analyze the usage information and generate an analysis report;
generate a periodic sharing information according to the analysis report, and share the periodic sharing information to the social platform.

7. The electronic cigarette social device of claim 6, wherein the operation data further comprises a location of use of the electronic cigarette device.

8. The electronic cigarette social device of claim 6, wherein the usage information further comprises a setting data for setting whether the usage information is sharable, and the one or more programs further cause the processor to:
determine whether the usage information is sharable according to the setting data;
determine whether the electronic cigarette device is in use according to the time of usage, when the usage information is sharable;
wherein the first sharing information is generated when the electronic cigarette device is in use.

9. The electronic cigarette social device of claim 8, wherein the one or more programs further cause the processor to:
determine whether the usage information comprises an evaluation data, when it is determined that the electronic cigarette device is not being used; and
generating a second sharing information according to the evaluation data, and share the second sharing information to the social platform.

10. The electronic cigarette social device of claim 9, wherein the evaluation data comprises a type of liquid tobacco, a taste sensation thereof, a record of heating applied, and a degree of satisfaction.

11. The electronic cigarette social device of claim 6, wherein
the electronic cigarette social device further comprises a display unit; and
the one or more programs further cause the processor to:
control the display unit do display the periodic sharing information and the analysis report.

12. An electronic cigarette social method, applied to an electronic cigarette device and an electronic cigarette social device, the method comprising:
receiving, by the electronic cigarette social device, a usage information comprising an operation data transmitted by the electronic cigarette device, the operation data comprising a time of usage;
generating, by electronic cigarette social device, a first sharing information according to the usage information, and sharing the first sharing information to a social platform;
analyzing, by the electronic cigarette social device, the usage information, and generating an analysis report;
generating, by the electronic cigarette social device, a periodic sharing information according to the analysis report, and sharing the periodic sharing information to the social platform.

13. The electronic cigarette social of claim 12, wherein the electronic cigarette device comprises a GPS unit for acquiring a location of use of the electronic cigarette device, and the operation data further comprise the location of use of the electronic cigarette device.

14. The electronic cigarette social of claim 12, wherein the usage information further comprises a setting data for setting whether the usage information is sharable, after receiving the usage information transmitted by the electronic cigarette device, the method further comprises:
determining, by the electronic cigarette social device, whether the usage information is sharable according to the setting data; and
determining, by the electronic cigarette social device, whether the electronic cigarette device is in use, when the usage information is sharable;
wherein the first sharing information is generated when the electronic cigarette device is in use.

15. The electronic cigarette social of claim 14, further comprising:
determine whether the usage information comprises an evaluation data, when it is determined that the electronic cigarette device is not is use; and
generating a second sharing information according to the evaluation data, and share the second sharing information to the social platform.

16. The electronic cigarette social of claim 15, wherein the evaluation data comprises a type of liquid tobacco, a taste sensation thereof, a record of heating applied, and a degree of satisfaction, wherein
the electronic cigarette device comprises a sensor unit configured to sense a pressing of a button on the electronic cigarette device, a shaking of the electronic cigarette device, or a gesture of the user, and send a sensing signal; and
the usage satisfaction degree of the electronic cigarette device is evaluated according to the sensing signal sent by the sensor unit.
